(19) United States
(12) Patent Application Publication
(10) Pub. No.: US 2025/0289490 A1
(43) Pub. Date: Sep. 18, 2025

(54) DOLLY IDENTIFICATION SYSTEM AND METHOD

(71) Applicant: Logistics and Supply Chain MultiTech R&D Centre Limited, Pok Fu Lam (HK)

(72) Inventors: Chun On Wong, Pok Fu Lam (HK); Chun Hung Chen, Pok Fu Lam (HK); Ho Lam, Pok Fu Lam (HK); Shiu Kee Luk, Pok Fu Lam (HK); Ka Leung Lau, Pok Fu Lam (HK)

(21) Appl. No.: 18/606,130

(22) Filed: Mar. 15, 2024

(51) Int. Cl. B62B 5/00

(52) U.S. Cl. CPC B62B 5/0096; B62B 5/0079; B62B 2202/24

(57) ABSTRACT

A dolly identification system including a towing vehicle including a coupler, a towing vehicle pairing scanner positioned on a towing vehicle, a dolly for carrying a load, wherein the dolly is capable of being removably coupled to the towing vehicle via the mechanical coupler, a wireless transceiver positioned on the dolly and configured to broadcast pairing signals, the towing vehicle pairing scanner configured to wirelessly pair with the wireless transceiver thereby wirelessly pairing the dolly to the towing vehicle to define a wireless connection, wherein the towing vehicle pairing scanner is configured to receive data signals including one or more logistics data from the wireless transceiver after the wireless connection is established.

### FIELD OF THE INVENTION

The present invention relates to a dolly identification system and method for identifying one or more dollies and/or identifying one or more data related to one or more dollies coupled to a towing vehicle.

### BACKGROUND

A dolly is a platform on wheels i.e., a wheeled vehicle that is used for moving heavy objects or moving loads. Dollies are commonly used to transport various goods around indoor facilities such as for example warehouses, storage lockers or in outdoor facilities such as for example airports, seaports, storage facilities etc. Dollies are commonly used for stock management and assist in transporting large loads. These dollies are often towed i.e., pulled by a towing vehicle such as for example a tractor or a tug or forklift or another powered vehicle. A towing vehicle generally pulls multiple dollies around a facility.

The tractor can often connect to multiple dollies, each carrying a different load. These dollies are generally connected in a series arrangement (i.e., in a chain) by suitable mechanical couplers. Each dolly in the series may be loaded with a different load. It is challenging for an operator to know the exact loads that may be connected to the towing vehicle since the line of sight of the operator may be blocked by the load on one or more dollies. The variation in the loads can make it difficult for an operator to track which loads are being pulled. It is further a logistics challenge, especially in a busy facility to track movement of specific loads.

The loads being carried may be of different sizes or weights, i.e., each dolly within a chain may have a different type and size of load. This again can make it challenging to track the specific loads being transported. Additionally, the operators of the towing vehicle have no real way to confirm that each dolly in the chain is securely coupled. There is a chance that one or more dollies may become decoupled without the towing vehicle operator's (e.g., tractor operator's) knowledge. This can be a collision risk in a busy facility such as a seaport or an airport. It is impractical for an operator of the towing vehicle to constantly check if dollies are attached.

Dollies or trollies or other similar devices can be used in indoor or outdoor environments. These need to be operated in all weather conditions. Again, in indoor and outdoor facilities, it can be challenging for the operator of the towing vehicle to track if all the dollies are being pulled and the specifics loads being carried on each dolly due to low visibility due to bad weather, low light and other obstructions that can obscure line of sight.

### SUMMARY

The present invention relates to a dolly identification system for identifying one or more dollies and/or identifying one or more data related to one or more dollies coupled to a towing vehicle. The present invention may further relate to a dolly identification system for identifying one or more dollies and tracking one or more dollies coupled to a towing vehicle.

The towing vehicle may be any suitable vehicle that is configured to physically i.e., mechanically connect to one or more dollies and pull the one or more dollies. Some examples can be a tractor or a tug or a forklift etc. the one or more dollies are configured to wirelessly pair with the towing vehicle and transmit data related to the one or more dollies. The data related to the one or more dollies may include, but is not limited to, the location of each dolly, a pairing status, the load carried by each dolly and the occupancy status of each dolly. Each dolly is configured to wirelessly pair with the towing vehicle by using a wireless protocol such as for example Bluetooth or Wi-Fi or Wi-Fi Direct or RFID or Zigbee or another wireless protocol.

According to one aspect of the invention, there is provided a dolly identification system comprising:
a towing vehicle including a coupler,
a towing vehicle pairing scanner positioned on a towing vehicle,
a dolly for carrying a load, wherein the dolly is capable of being removably coupled to the towing vehicle via the mechanical coupler,
a wireless transceiver positioned on the dolly and configured to broadcast pairing signals,
the towing vehicle pairing scanner configured to wirelessly pair with the wireless transceiver thereby wirelessly pairing the dolly to the towing vehicle to define a wireless connection,
wherein the towing vehicle pairing scanner is configured to receive data signals including one or more logistics data from the wireless transceiver after the wireless connection is established.

In one example the towing vehicle pairing scanner is configured to: detect a pairing signal broadcast from one or more wireless transceivers, wherein a wireless transceiver is associated with a dolly,
identify the one or more wireless transceivers based on the received pairing signal,
pairing with the one or more wireless transceivers to establish a wireless connection, and,
receive data related to the dolly associated with wireless transceiver.

In one example the broadcast pairing signal comprises an ID of the wireless transceiver. The broadcast pairing signal may be an advertising signal, that may be transmitted at regular intervals.

In one example the data signals comprise a plurality of logistics data encoded therein, the towing vehicle pairing scanner configured to process the data signals received and identify one or more logistics data, wherein the logistics data comprises one or more of:
location of the dolly,
pairing status,
occupancy status,
size or weight of the load,
type of load being carried.

In one example the towing vehicle comprises a wireless communication module, and the received logistics data are transmitted to a logistics computing system via the wireless communication module. The logistics data may transmit to the logistics computing system are regular intervals. The wireless communication module may be configured to operate in a different protocol to the pairing scanner and the wireless transceivers.

In one example the towing vehicle pairing scanner is configured to determine the pairing status reported by the wireless transceiver of a dolly at regular intervals.

In one example the towing vehicle pairing scanner is configured to:
detect pairing signals from a plurality of wireless transceivers, wherein a transceiver is associated with a dolly,
determine a position of the wireless transceiver and associated dolly based on a RSSI value of the pairing signal received from each wireless transceiver.

In one example the towing vehicle pairing scanner is configured to determine the position of the wireless transceiver and associated dolly based on the ID value and RSSI value in the pairing signal received from each wireless transceiver.

In one example the towing vehicle pairing scanner may determine the specific dollies that are paired based on processing the regularly transmitted pairing signals or based on receiving a pairing status from the wireless transceivers. The pairing scanner may be configured to simultaneously pair with multiple wireless transceivers.

In one example the dolly identification system comprises a plurality of dollies, each dolly comprising a wireless transceiver, and the dollies are configured to mechanically couple to each other in series and couple to the towing vehicle,
wherein the towing vehicle pairing scanner is configured to receive pairing signals from each wireless transceiver associated with a dolly,
the towing vehicle paring scanner is configured to:
identify each wireless transceiver and associated dolly based on the RSSI value and ID of each received pairing signal,
pair with one or more wireless transceivers based on the RSSI value and ID,
receive data including logistics data from the paired wireless transceivers, and;
transmit the received data or the logistics data to a logistics computing system.

In one example the logistics computing system is configured to:
receive the one or more logistics data,
process the received logistics data,
identify one or more dollies that have been paired and/or the order of the dollies that are connected.

In one example the towing vehicle pairing scanner is oriented to face a coupling direction of the mechanical coupler such that the line of sight of the towing vehicle pairing scanner is in the coupling direction of the mechanical coupler.

In one example each dolly comprises a link that is complementary to the mechanical coupler and configured to removably attach to the mechanical coupler to removably connect the dolly to the towing vehicle, and wherein the wireless transceiver oriented to face in a coupling direction of the link.

In one example the wireless transceiver is positioned on or adjacent the mechanical link and is oriented to face in the direction of the link such that the wireless transceiver has line of sight to the pairing scanner when the dolly is coupled to the towing vehicle.

In one example each dolly comprises a dolly pairing scanner, wherein the dolly pairing scanner is positioned on the dolly and configured to detect signals broadcast by one or more wireless transceivers, and the dolly pairing scanner further configured to determine the position of a detected wireless transceiver and associated dolly based on the ID value and RSSI value in the pairing signal received from each wireless transceiver.

In one example each wireless transceiver is an RF transceiver configured to transmit RF signals, the towing vehicle pairing scanner is an RF pairing scanner configured to detect and receive RF signals, and wherein the wireless transceivers and the towing vehicle pairing scanner defining a wireless RF network.

In one example each wireless transceiver is a Bluetooth transceiver and the towing vehicle pairing scanner is a Bluetooth pairing scanner,
the wireless transceiver and towing vehicle pairing scanner are configured to communicate by Bluetooth protocol, and
the wireless transceivers and the towing vehicle pairing scanner form a piconet network.

In an alternative example, each wireless transceiver is a Wi-Fi module that may be configured to transmit Wi-Fi signals, the pairing scanner may be a Wi-Fi scanner configured to detect a Wi-Fi pairing signal e.g., a beacon frame or a probe request and pair with the wireless transceiver,
the wireless transceiver and the towing vehicle pairing scanner are configured to communicate with each other by a Wi-Fi protocol, and the wireless transceivers and the pairing scanner may define a WLAN network.

In one example the wireless transceivers may further comprise a cellular communication module to allow cellular comms i.e., access cellular internet. The transceivers may be configured to form a Wi-Fi hotspot. Alternatively, the wireless transceivers may be a Wi-Fi access point device that is configured to generate a Wi-Fi network. In one example the pairing scanner may be a hotspot that the access points (transceivers) can wireless pair with.

In one example the data signals are transmitted from a dolly pairing scanner on a first dolly of the plurality of dollies to the wireless transceiver on the same dolly,
the data signals are transmitted to the dolly pairing scanner of a second dolly adjacent to first the dolly via the wireless transceiver of the first dolly, such that data signals being routed from one dolly to the next until the towing vehicle pairing scanner receives the data signals, and;
the towing vehicle pairing scanner configured to transmit the received data signals to a logistics computing system.

According to one aspect of the invention, there is provided an airport dolly identification and management system for tracking one or more dollies comprising:
a towing vehicle,
the towing vehicle comprises a towing vehicle pairing scanner disposed on the towing vehicle,
a plurality of dollies, each dolly comprising a wireless transceiver,
the dollies are configured to mechanically couple to each other in series and couple to the towing vehicle, wherein the towing vehicle is adapted to tow all the dollies,
wherein each wireless transceiver is configured to broadcast advertise signals,
wherein the towing vehicle pairing scanner is configured to receive the broadcast advertise signals from each wireless transceiver associated with a dolly,
the towing vehicle paring scanner is configured to:
identify each wireless transceiver and associated dolly based on the RSSI value and ID encoded within the broadcast advertise signals,
wirelessly pair with one or more wireless transceivers once the wireless transceivers are within pairing range, wherein the range is determined based on the RSSI value,
wherein the paired wireless transceivers and the towing vehicle pairing scanner forming a wireless RF network that utilises signals in a frequency range of 2.4 GHz to 5 GHZ,
receive data including logistics data from the paired wireless transceivers,
transmit the received data or the logistics data to a remote computing system, and;
wherein the logistics data comprises one or more of:
   location of the dolly,
   pairing status,
   occupancy status,
   type of load being carried.

The towing vehicle may be for example an airport tractor or tug. In one example the dollies may be airport dollies or trollies or carts for transporting airport or ground support items, goods, equipment or other things.

In one example each wireless transceiver comprises a Bluetooth transceiver or a Wi-Fi transceiver,
the towing vehicle pairing scanner comprising a Bluetooth scanner or a Wi-Fi scanner, and;
the towing vehicle pairing scanner configured to receive data signals from each wireless transceiver over the network either directly or routed through a dolly pairing scanner.

According to one aspect of the invention, there is provided a dolly identification method comprising the steps of:
receiving at a towing vehicle pairing scanner one or more pairing signals broadcast by a wireless transceiver,
wherein the towing vehicle pairing is configured to be provided on a towing vehicle and the wireless transceiver is provided on a dolly, in use, the dolly is configured to mechanically couple to the towing vehicle,
wherein the dolly is configured to carry equipment,
wirelessly pairing the towing vehicle pairing scanner with the wireless transceiver based at least on the RSSI value of the pairing signal,
receiving at the towing vehicle pairing scanner data signals from the wireless transceiver including one or more logistics data,
wherein the logistics data comprising one or more of:
   location of the dolly,
   pairing status,
   occupancy status,
   type of load being carried,
transmitting the received logistics data to a logistics computing system.

The term dolly as used herein means any platform on wheels that is used to carry equipment or goods. The term dolly can refer to a trolley or cart or other wheeled platform for carrying equipment of goods. The term dolly can define a dolly or trolley or cart or wheeled platform of any size to carry any equipment. The term dolly can be used to refer to any platform with wheels that is used in logistics management i.e., used for transporting goods and equipment in any indoor or outdoor environment, such as for example in warehouses, airports, seaports etc.

In this specification the term airport dolly refers to a platform with wheels that is used to hold and transport airport equipment (i.e., ground support equipment) and other aircraft equipment. Airport dollies can be used to transport bags, mail bags, cartons, etc.

### BRIEF DESCRIPTION OF THE DRAWINGS

Embodiments of the present invention will now be described, by way of example, with reference to the accompanying drawings in which:

FIG. 1 illustrates an example dolly identification system.

FIG. 2 is one example of the data flow between the components of the dolly identification system of FIG. 1.

FIG. 3 is an alternate example of the data flow between the components of the dolly identification system of FIG. 1.

FIG. 4 illustrates a schematic diagram of one example of the towing vehicle pairing scanner.

FIG. 5 illustrates a schematic diagram of one example of the wireless transceiver.

FIG. 6 illustrates the functions performed at the logistics computing system.

### DETAILED DESCRIPTION OF THE PREFERRED EMBODIMENTS

The present invention relates to a dolly identification system for identifying one or more dollies that are used coupled to a towing vehicle. The dolly identification system 100 can be used to identify one or more dollies that are used to haul or move equipment around. As explained earlier, it is challenging to determine the dollies that are attached to and being towed by a towing vehicle. Additionally, it is difficult for a towing vehicle operator to visually check the connected dollies or identify the equipment being carried due to line of sight being blocked and/or different sized equipment. Further other known systems e.g., using cameras etc require a lot of power which can reduce practicality.

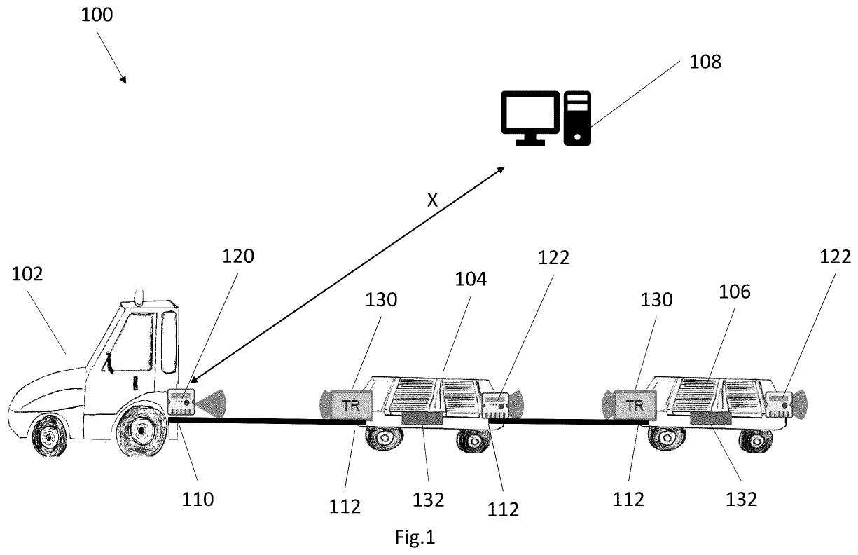

Referring to FIG. 1, an embodiment of the present invention is illustrated. This embodiment is arranged to provide a dolly identification system 100 comprising:
a towing vehicle including a coupler,
a towing vehicle pairing scanner positioned on a towing vehicle,
a dolly for carrying a load, wherein the dolly is capable of being removably coupled to the towing vehicle via the mechanical coupler,
a wireless transceiver positioned on the dolly and configured to broadcast signals,
the towing vehicle pairing scanner configured to wirelessly pair with the wireless transceiver thereby wirelessly pairing the dolly to the towing vehicle to define a wireless connection, wherein the towing vehicle pairing scanner is configured to receive data signals including one or more logistics data from the wireless transceiver after the wireless connection is established. The logistics data may be transmitted to a remote computing system e.g., a logistics computing system for further processing.

Referring to FIG. 1 the dolly identification system 100 comprises a towing vehicle 102 that is mechanically coupled to one or more dollies 104, 106+−. The towing vehicle 102 is configured to tow i.e., pull the one or more dollies 104, 106. In the illustrated example of FIG. 1, two dollies 104, 106 are being towed by the towing vehicle 102. The towing vehicle 102 may be configured to pull a single dolly or any plurality of dollies. The illustrated example of FIG. 1 illustrates an example airport dolly identification and management system 100. The dollies 104, 106 may be adapted for use in airports to transport various equipment or goods such as for example baggage, cargo, boxes or other ground support equipment.

The towing vehicle 102 may be tractor or a tug or truck or a forklift or other suitable vehicle that can be used to tow (i.e., pull) one or more dollies. The towing vehicle 102 comprises a mechanical coupler 110. The coupler 110 may be a mechanical rod or a tow bar or other suitable coupler to couple with dolly 104, 106. The towing vehicle 102 comprises an engine and wheels. Each dolly 104, 106 comprises a flat bed and a plurality of wheels and a mechanical link 112 that is complementary to the mechanical coupler 110. The dollies 104, 106 may be configured to removably connect to each other via the mechanical links 112. Each dolly can connect to another dolly by removably connecting the mechanical links 112. Each dolly may comprise a mechanical link 112 positioned at each opposing end of the dolly.

The towing vehicle 102 comprises a towing vehicle pairing scanner 120. The wireless pairing scanner 120 is positioned on a rear face of the towing vehicle. In one example the towing vehicle pairing scanner 120 may be positioned adjacent the mechanical coupling 110. The towing vehicle pairing scanner 120 is oriented to face a coupling direction of the mechanical coupler 110 such that the line of sight of the towing vehicle pairing scanner is in the coupling direction of the mechanical coupler 110.

Each dolly 104, 106 comprises a wireless transceiver 130. The wireless transceiver 130 may be disposed on the dolly 104, 106. The wireless transceiver 130 may be oriented to face in a coupling direction of the link 112. The wireless transceiver 130 may be positioned on or adjacent the mechanical link 112. The wireless transceiver 130 on each dolly 104, 106 may be oriented to face in the direction of the link 112. The wireless transceiver 130 may positioned and oriented such that the transceiver 130 has line of sight to a pairing scanner in front.

Each dolly may optionally comprise a dolly pairing scanner 122. The dolly pairing scanner 122 may be similar in structure to the towing vehicle pairing scanner. The dolly pairing scanner 122 may be configured to detect pairing signals from one or more transceivers and pair with at least one transceiver 130.

Each dolly 104, 106 may optionally comprise one or more sensors 132. The sensors 132 may be disposed on the flat bed of the dolly 104, 106. Additionally, or alternatively the sensors may be disposed on other portions e.g., on the link, or wheels etc. The sensors 132 may comprise any suitable sensors that may be used to sense the loads being carried by the dollies. For example, the sensors 132 may be a sensor pad disposed on the bed of the dolly, as shown in FIG. 1. The sensors may be for example, load sensors, mass sensors, piezo sensors or any other sensors that may be configured to detect the load being carried on the dolly. Each dolly 104, 106 may optionally comprise sensors 132 that may be configured to detect the type of load or type of equipment being carried, e.g., cameras or optical sensors etc. In one example, each dolly 104, 106 may optionally comprise one or more sensors 132 that may be configured to detect the type and size (i.e., amount) of load. The sensors 132 may be used to determine if the dolly is being used and/or how full the dolly is.

The dollies 104, 106 may be preferably coupled in a series arrangement, i.e., a consecutive arrangement, as shown in FIG. 1. The dollies 104, 106 may be removably connected to each other and one dolly may be directly connected to the towing vehicle 102. The system 100 comprises a remote computing system, e.g., a logistics computing system 108. The logistics computing system 108 is arranged in wireless communication with a towing vehicle pairing scanner 120. The logistics computing system 108 may be in two-way communication with the towing vehicle pairing scanner 120. The towing vehicle pairing scanner 120 is configured to wirelessly pair with one or more of the wireless transceivers 130. The pairing scanner 120 may be configured to receive logistics data from the wireless transceivers 130. The pairing scanner 120 may be configured to transmit the logistics data to the logistics computing system 108.

The logistics data may be determined by the pairing scanner 120. Alternatively, the logistics data may be determined or calculated in the logistics computing system 108. The logistics data may comprise one or more of: location of the dolly, pairing status, occupancy status, or type of load being carried, size of load, weight of the load or other data related to the load and/or dolly.

The logistics computing system 108 may be further configured to receive the data, process the data and store the data. For example, the logistics computing system 108 may be configured to identify the arrangement of dollies, the loads being carried, the occupancy of each dolly (i.e., which dollies are carrying a load) and other parameters. The received logistics data may be used to track the movement of one or more dollies. The logistics data may be used for logistics management in environments such as airports, seaports, warehouses etc. Optionally, the logistics computing system 108 may be configured to transmit commands to the towing vehicle e.g., such as for example waypoints or a required path. In another example the logistics computing system 108 may further be configured to communicate with the driver of one or more tractors.

In one example the logistics computing system 108 may be implemented by a computer having an appropriate user interface. The computer may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computer (i.e., logistics computing system 108) may be appropriately programmed to implement functions such as for example processing logistics data or determining logistics data etc. The logistics computing system 108 may include computer storage media, transient and non-transient memory devices having computer instructions or software codes stored therein, which can be used to program or configure the computing devices, computer processors, or electronic circuitries to perform any of the processes of the present disclosure e.g., receiving logistics data, processing logistics data and storing logistics data. The storage media, transient and non-transient memory devices can include, but are not limited to, floppy disks, optical discs, and magneto-optical disks, ROMs, RAMs, flash memory devices, or any type of media or devices suitable for storing instructions, codes, and/or data. Data received at the computing system 108 may be processed to extract one or more parameters such as for example, usage patterns of the dollies or types of loads moved etc. The data received at the computing system 108 may also be stored in an appropriate storage media.

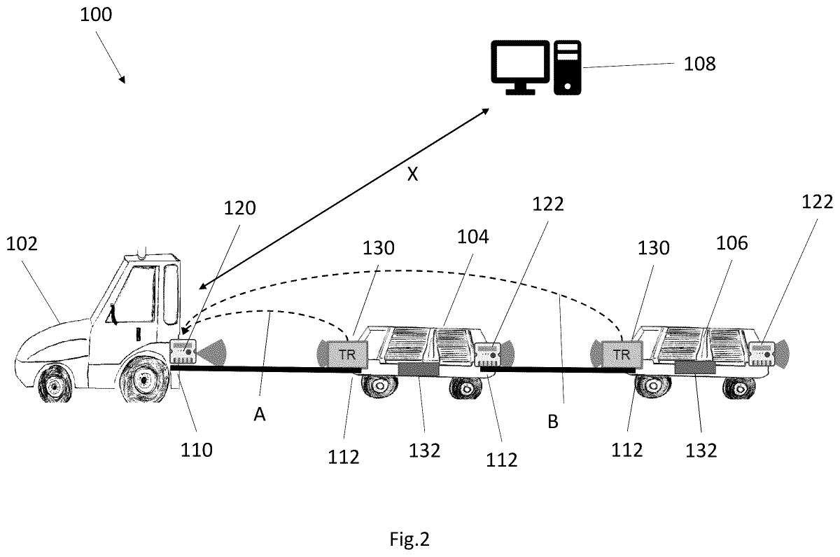

FIG. 2 illustrates one example of the data flow between the components of the dolly identification system 100 of FIG. 1. Each wireless transceiver 130 is configured to broadcast a pairing signal at regular intervals. The pairing signal may be an advertise signal i.e., the wireless transceiver 130 is configured to regularly advertise its presence. The pairing scanner 130 is configured to determine the pairing status reported by the wireless transceiver 120 of a dolly at regular intervals.

The broadcast pairing signal may comprise an ID of the wireless transceiver 130. For example, the ID may comprise a SSID or a MAC address, a device name or another identifier that is unique to a specific wireless transceiver 130. Each wireless transceiver 130 may comprise a unique ID. The broadcast pairing signal may be an advertise signal. Each wireless transceiver 130 may be configured to advertise its availability to pair. In one example the broadcast pairing signal may be a beacon frame that is transmitted at regular intervals. In another example the broadcast pairing signal may be a probe request that may be transmitted by each wireless transceiver 130 searching to pair with a pairing scanner.

The pairing scanner 120 is configured to detect the pairing signals broadcast from the plurality of wireless transceivers 130. The pairing scanner 120 is configured to identify the one or more wireless transceivers based on the received pairing signals. The pairing scanner 120 is configured to detect a wireless transceiver 130 based on at least the ID value. In another example the pairing scanner 120 may be configured to detect the wireless transceivers 130 based on the ID and the signal strength i.e., the RSSI value. The pairing scanner 120 is configured to pair with and establish a wireless connection with the appropriate wireless transceivers. In one example the towing vehicle pairing scanner 120 is configured to determine the pairing status reported by the wireless transceiver of a dolly at regular intervals

In one example the pairing scanner 120 is configured to detect pairing signals from a plurality of wireless transceivers 130. The pairing scanner 120 is configured to determine a position of the wireless transceiver and associated dolly based on a RSSI value of the pairing signal received from each wireless transceiver. In one example, the pairing scanner 130 is configured to determine the position of each wireless transceiver and associated dolly based on the ID value and RSSI value in the pairing signal received from each wireless transceiver 120.

The pairing scanner 120 may be configured to receive pairing signals from a plurality of wireless transceivers 130. The pairing scanner 120 is configured to pair with multiple wireless transceivers 130 simultaneously.

Each wireless transceiver 130 may be a RF transceiver configured to transmit RF signals. The towing vehicle pairing scanner 120 may be an RF pairing scanner configured to detect and receive RF signals. The wireless transceivers and the towing vehicle pairing scanner may define a wireless RF network. The pairing scanner and wireless transceivers may operate via a wireless RF protocol e.g., Bluetooth or Wi-Fi or another wireless RF protocol. The pairing scanner 120 and the wireless transceivers 130 may form a Piconet or a WLAN network or an RF LAN network. Wireless transceivers may join or leave the network based on if the transceivers are paired with the pairing scanner 120 or not.

The pairing scanner 120 may be configured to pair with one or more wireless transceivers based on the RSSI value and ID. The pairing scanner 120 is configured to receive data including logistics data from the paired wireless transceivers 130. As shown in FIG. 2, the pairing signals A and B are illustrated. The data connection is also used to transmit data signals including logistics data to the pairing scanner 120 from the wireless transceivers 130. In the example of FIG. 2, the dolly pairing scanners 122 are not utilised, or may be utilised to facilitate signal transfer. The dolly pairing scanners 122 may function as routers and may route pairing signals and/or data to the towing vehicle pairing scanner 120. The data may be transmitted along the same paths A and B shown from each wireless transceiver 130 to the pairing scanner 120. The pairing scanner 130 may be configure to simultaneously pair with and receive regular pairing updates from a plurality of wireless transceivers 130, each transceiver being mounted on a dolly. Additionally, the pairing scanner 120 is configured to simultaneously receive from logistics data from a plurality of the wireless transceivers 130.

The pairing scanner 120 is configured to transmit the received logistics data to a logistics computing system 108. The logistics computing system 108 may be configured to receive the one or more logistics data, process the received logistics data, and identify one or more dollies that have been paired and/or the order of the dollies that are connected. The logistics computing system 108 may be configured to perform the functions described earlier.

In the example form of FIG. 2, the pairing scanner 120 may receive data simultaneously from the wireless transceivers 130. The pairing scanner 120 may receive logistics data from each dolly simultaneously. Alternatively, the scanner 120 may receive the logistics data from each dolly within quick succession e.g., within milliseconds. This is advantageous because the pairing scanner 120 receives logistics data quickly and allow for real time receipt of logistics data.

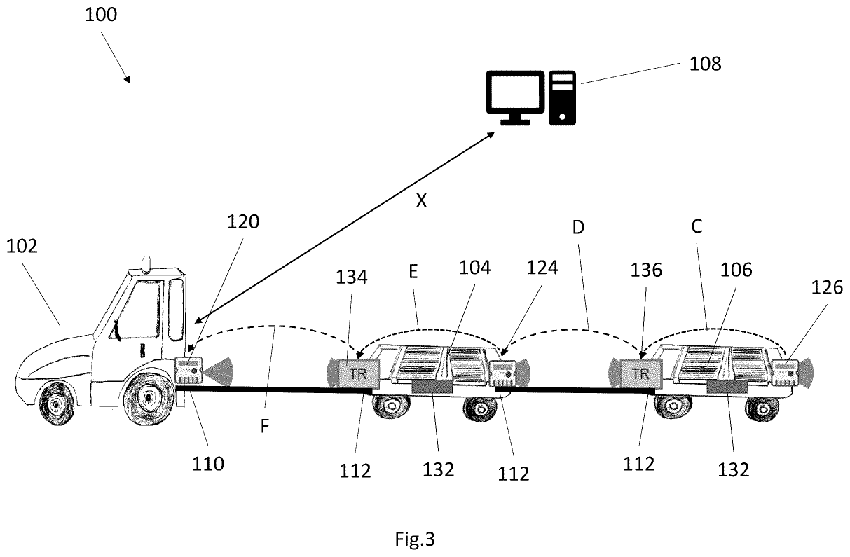

FIG. 3 illustrates an alternate example of the data flow between the components of the dolly identification system of FIG. 1. In the example implementation of FIG. 3, the towing vehicle pairing scanner 120 may wirelessly pair with wireless transceiver that is closest wireless transceiver 130. Each pairing scanner 120, 122 may detect one or more transceivers 130 and determine which dolly to pair with based on the RSSI value and optionally the ID of each transceiver.

The dolly pairing scanners 122 may be configured to wirelessly pair with one or more transceivers 130 that closest to it i.e., within a specific distance away. The distance may be determined based in the RSSI (i.e., signal strength). The dolly pairing scanners 122 may function as routers to route data to the towing vehicle pairing scanner 120.

In one example the data signals are transmitted from a dolly pairing scanner on a first dolly 104 of the plurality of dollies to the wireless transceiver on the same dolly. The data signals may be transmitted to the dolly pairing scanner of a second dolly 106 adjacent to first the dolly 104 via the wireless transceiver 130 of the first dolly 104, such that data signals being routed from one dolly to the next until the towing vehicle pairing scanner 120 receives the data signals. The towing vehicle pairing scanner 120 is configured to transmit the received data signals to a logistics computing system 108.

Referring to FIG. 3, the data may be wirelessly transmitted from the second dolly pairing scanner 126 may wirelessly transmit data to the second dolly wireless transceiver 136. This is denoted by arrow C. The second dolly wireless transceiver 136 is configured to transmit data to the first dolly pairing scanner 124 as shown by arrow D. The first dolly pairing scanner 124 is configured to transmit the data signals to the first dolly wireless transceiver 134, denoted by arrow E. The first dolly wireless transceiver 134 is configured to transmit data to the towing vehicle pairing scanner 120, denoted by arrow F. The towing vehicle pairing scanner 120 is configured to transmit the received data to a remote computing system 108 i.e., the logistics computing system 108.

The pairing scanner 120 may be configured to cache the received logistics data. The pairing scanner 120 may further be configured to perform additional pre-processing e.g., filtering data or de-noising data. The cached data may be then transmitted to the logistics server 108 (i.e., logistics computing system 108). The cached data may be transmitted at regular intervals. This can help to reduce bandwidth.

Alternatively, the pairing scanner 120 may be configured to transmit logistics data in substantially real time to the logistics server 108. The scanner 120 may transmit data soon after it is received. This is advantageous as the data can be received at the server 108 quickly for processing.

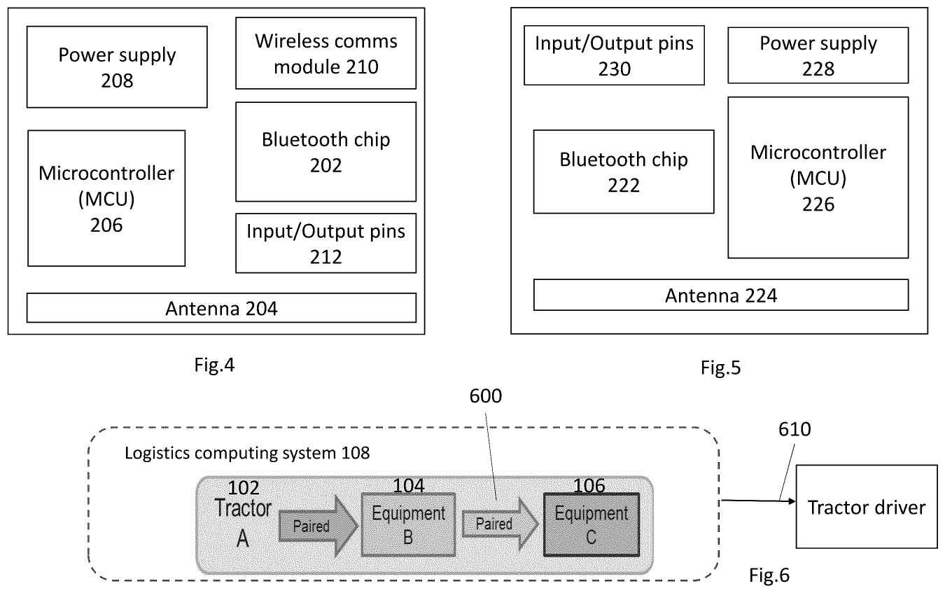

FIG. 4 illustrates a schematic diagram of one example of the towing vehicle pairing scanner 120. The towing vehicle pairing scanner 120 may be a Bluetooth device configured to communicate using the Bluetooth protocol. The pairing scanner 120 may comprise a Bluetooth chip 202 that handles the Bluetooth communication protocol. The Bluetooth chip 202 may comprise a Bluetooth radio, baseband processor and optionally an integrated antenna. The scanner 120 may further comprise an antenna 204 to aid with RF communications. A microcontroller 206 is operatively coupled to the other components and is configured to handle higher level functions such as for example initial processing of the received data to identify the logistics data or to identify RSSI values etc.

A power supply 208 is integrated into the scanner 120. The power supply may be a battery or other power supply typically having an operating range of 3.3V to 5V. The scanner may further comprise Input/Output pins 212 that allow interfacing with external devices or sensors or other peripherals.

The towing vehicle pairing scanner further comprises a wireless communication module 210. The received logistics data are transmitted to a logistics computing system 108 via the wireless communication module 210. The wireless communication module 210 may be cellular communication module or other wireless communication module that uses long range transmission protocol. The wireless communication module 210 is configured to use a different protocol to the pairing scanners and wireless transceivers.

Optionally, the pairing scanner 120 may comprise a UART or serial interface for UART or serial communications. The scanner 120 may further comprise a voltage regulator to enable stable power. The scanner 120 may further comprise one or more LEDs to indicate status such as paired, power level, data transmission etc. The scanner 120 may further include firmware that defines the behaviour of the scanner. In one example the dolly pairing scanners may also have the same construction as the towing vehicle pairing scanner 120. Alternatively, the dolly pairing scanners e.g., 122, 124, 126 may not include a wireless communication module.

FIG. 5 illustrates a schematic diagram of the wireless transceiver 130. The wireless transceiver 130 may be a Bluetooth device configured to communicate with a Bluetooth protocol. The wireless transceiver 130 comprises Bluetooth Module 222 i.e., a Bluetooth chip that may include a Bluetooth radio, baseband processor and optionally an integrated antenna. The Bluetooth module 222 may be configured to broadcast pairing signals and then transmit data via Bluetooth protocol once paired. Optionally, the transceiver 130 may comprise an antenna 224. The wireless transceiver 130 may comprise a microcontroller 226. The microcontroller 226 may control operation of the Bluetooth chip 222. The microcontroller 226 may further encode data for wireless transmission to the pairing scanner.

The wireless transceiver 130 further comprises a power source 228. The power source may be a battery or other power supply typically having an operating range of 3.3V to 5V. The wireless transceiver 130 may comprise a sensor input pins 230. The sensor input pins 230 allow one or more sensors 230 to be connected to the wireless transceiver 130. For example, the sensor inputs 230 may connect to the sensors 132. The sensors measurements may be processed by the microcontroller 226. The measured parameters such as the amount of load may be determined by the controller 226 and then transmitted wirelessly to the pairing scanner 120.

FIG. 6 illustrates a diagram of the functions performed at the logistics computing system 108 (i.e., logistics server 108). The logistics computing system 108 i.e., logistics server is configured to receive data including for example location, pairing status, occupancy status etc, as received by the pairing scanner 120. The logistics computing system 108 may be configured to identify the specific dollies that are paired based on the received data.

In the illustrated example of FIG. 6, the computing system 108 is configured to identify equipment connection order 600. The equipment (i.e., dolly) connection order may be used to determine the specific dollies that are attached and the order they are attached in. As shown in FIG. 6 equipment B (104) is paired with and connected to the tractor A (102). The equipment C (106) is paired with and connected to equipment B (104). Equipment B (104) and equipment C (106) represent dollies. The server 108 may determine the position of each dolly (i.e., equipment) as shown in 600. The specific dollies may be identified based on the ID in the data received. The server 108 may also be configured to track the location of the specific equipment based on the ID and RSSI signal. As shown in FIG. 6, the server 108 can determine the position of dolly B and dolly C based on the RSSI and ID.

The server 108 may further be configured to track other parameter such as for example the pairing status i.e., are the dollies paired or not. Further the server 108 may determine the amount of time the dollies are paired. The server 108 may further determine the path each dolly has travelled. The logistics computing system 108 i.e., logistics server 108 may be programmed to calculate additional parameters that may be used in logistics and managing equipment movement in the specific environment such as for example at an airport or seaport.

In a further example the computing system 108 may be configured to communicate to the driver of the towing vehicle the specific dollies (i.e., equipment) that is connected. The computing system 108 may be configured to communicate a pick list i.e., list of dollies to pick up and transport. The dolly identification system 100 allows the driver to verify the correct dollies have been picked up. This is shown in FIG. 6 with the message 610 being transmitted to the tractor driver (i.e., towing vehicle driver). The computing system 108 may transmit a message to a towing vehicle driver mobile device or to the towing vehicle pairing scanner 120. The pairing scanner 120 may be configured for two-way communications and may further communicate messages from the computing system 108 to the towing vehicle driver's mobile device. The two-way communication is indicated by arrow X.

The pairing operation between the towing vehicle 102 and one or more dollies 104, 106 is dynamic. The interaction is not a pre-allocated or predetermined operation. The towing vehicle can pair with one or more dollies when the dollies are within range i.e., within pairing range that the pairing signals can be exchanged between the towing vehicle and the one or more dollies 104, 106. The pairing can occur when the dollies 104, 106 are within pairing range i.e., close enough to the towing vehicle 102.

Alternatively, towing vehicle 102 may pair with the closest dolly 104, which can in turn pair with other adjacent dollies 106. The pairing may occur similar to the arrangement shown in FIG. 3. In this arrangement pairing between the towing vehicle 102 and dolly is not predetermined and occurs when the dolly is within a pairing range to the towing vehicle 102.

Each paired dolly 104, 106 can be identified based on the ID value of the dolly or the ID of the transceiver of the dolly. The logistics computing system 108 can track the load on the dolly based on tracking the ID of the dolly and the logistics information transmitted to the logistics computing system 108. Each dolly 104, 106 may correspond to a specific load. The load data may be incorporated into the logistics data that is transmitted to the logistics computing system 108. This allows the load to be tracked around a facility as the position of the dolly 104, 106 is tracked.

In use, individual dollies are not returned to pre-allocated positions or return sites after use. In use, dollies may be left anywhere around a facility after use. Often dollies are left where they are after they are unloaded. The specific arrangement of dollies that are coupled to the towing vehicle can vary each time. This is because dollies are attached from any random location where dollies may be left. The use of each dolly 104, 106 may be tracked in real time by the logistics server 108 based on the received logistics data. The server 108 may be arranged to process logistics data and track movement of the dollies in real time. The server 108 may further be configured to determined usage patterns of the various dollies. The usage patterns may be extracted by the server 108 by processing the received logistics data. The logistics server 108 may also determine the most common types of loads, the commonly moved load weights or sizes or other logistics data.

Alternatively, the scanner 120 may comprise a processor that may be configured to receive data from the dollies and track movement of the dollies in real time. The data may be stored or cached and transmitted to the server 108 after the dollies have been towed to their destination. The logistics server 108 may further be configured to determine usage patterns or other data by processing the received logistics data.

The dolly identification system 100 as describe herein is advantageous because the towing vehicle driver can know the specific dollies (i.e., equipment) that is coupled to the towing vehicle. The dolly identification system 100 is configured to identify the dollies coupled to the towing vehicle based on the information gathered after pairing. This information may be presented to the towing vehicle operator. The dolly identification system is further advantageous because it can be used in indoor or outdoor environments.

The dolly identification system is advantageous because the towing vehicle can pair with multiple dollies simultaneously. The system 100 further does not require a line of sight and can operate even if towing vehicles line of sight is blocked by dollies or goods on dollies. The wireless pairing e.g., by using Bluetooth or Wi-Fi can operate through obstructions and do not require line of sight. The system is a robust system that can operate for a long time as there is minimal mechanical wear and tear on the wireless pairing. Further dolly identification is a low power consumption system therefore can operate with a small battery. The wireless pairing is performed using low power protocols such as Bluetooth which reduces the requirement for large power supplies. This makes the system 100 more widely usable.

The dolly identification system 100 further may continuously report the paired dollies. The dollies may continuously or at regular intervals report the pairing status to the towing vehicle pairing scanner. This reduces the need for a towing vehicle driver to visually inspect the pairing. The system 100 is advantageous as it allows regular tracking of the pairing status and can help identify any dollies that may have decoupled. This reduces the changes of any accidents due to stray, decoupled dollies. The dolly identification system 100 provides many advantages over current systems in managing the logistics of dollies (i.e., trollies, carts etc.) in a wide variety of environments. The system 100 is also advantageous as it may be capable of tracking use of dollies in real time. Real time tracking can be advantageous for airport dollies can be used to transport bags, mail bags, cartons, etc. These dollies are often never returned to a specific location. Therefore real time tracking the position of dollies as they are towed can help administrators or other parties to determine the location of these dollies as they are towed. The real time tracking also allows a party to locate dollies that are left unattended, as they last known position of the dolly may be accessed from the server 108. The position information may be used to locate the specific dolly.

Additionally, the logistics computing system 108 (i.e., server 108) is advantageous as the server may be configured to calculate usage patterns of the dollies or types of loads moved etc. This data allows for improved decision making by appropriate managers or decision makers.

Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand-alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated the figures may be rearranged and/or combined into a single component or embodied in several components without departing from the scope of the invention. Additional elements or components may also be added without departing from the scope of the invention. Additionally, the features described herein may be implemented in software, hardware, as a business method, and/or combination thereof.

What is claimed is:

1. A dolly identification system comprising:
a towing vehicle including a coupler,
a towing vehicle pairing scanner positioned on a towing vehicle,
a dolly for carrying a load, wherein the dolly is capable of being removably coupled to the towing vehicle via the mechanical coupler,
a wireless transceiver positioned on the dolly and configured to broadcast pairing signals,
the towing vehicle pairing scanner configured to wirelessly pair with the wireless transceiver thereby wirelessly pairing the dolly to the towing vehicle to define a wireless connection,
wherein the towing vehicle pairing scanner is configured to receive data signals including one or more logistics data from the wireless transceiver after the wireless connection is established.

2. A dolly identification system as per claim 1, wherein the towing vehicle pairing scanner is configured to:
detect a pairing signal broadcast from one or more wireless transceivers, wherein a wireless transceiver is associated with a dolly,
identify the one or more wireless transceivers based on the received pairing signal,
pairing with the one or more wireless transceivers to establish a wireless connection, and,
receive data related to the dolly associated with wireless transceiver.

3. A dolly identification system as per claim 2, wherein the broadcast pairing signal comprises an ID of the wireless transceiver.

4. A dolly identification system as per claim 1, wherein the data signals comprise a plurality of logistics data encoded therein,
the towing vehicle pairing scanner configured to process the data signals received and identify one or more logistics data, wherein the logistics data comprises one or more of:
location of the dolly,
pairing status,
occupancy status,
type of load being carried.

5. A dolly identification system as per claim 1, wherein the towing vehicle comprises a wireless communication module, and the received logistics data are transmitted to a logistics computing system via the wireless communication module.

6. A dolly identification system as per claim 1, wherein the towing vehicle pairing scanner is configured to determine the pairing status reported by the wireless transceiver of a dolly at regular intervals.

7. A dolly identification system as per claim 2, wherein the towing vehicle pairing scanner is configured to:
detect pairing signals from a plurality of wireless transceivers, wherein a transceiver is associated with a dolly,
determine a position of the wireless transceiver and associated dolly based on a RSSI value of the pairing signal received from each wireless transceiver.

8. A dolly identification system as per claim 7, wherein the towing vehicle pairing scanner is configured to determine the position of the wireless transceiver and associated dolly based on the ID value and RSSI value in the pairing signal received from each wireless transceiver.

9. A dolly identification system as per claim 1, comprising a plurality of dollies, each dolly comprising a wireless transceiver, and the dollies are configured to mechanically couple to each other in series and couple to the towing vehicle,
wherein the towing vehicle pairing scanner is configured to receive pairing signals from each wireless transceiver associated with a dolly,
the towing vehicle paring scanner is configured to:
identify each wireless transceiver and associated dolly based on the RSSI value and ID of each received pairing signal,
pair with one or more wireless transceivers based on the RSSI value and ID,
receive data including logistics data from the paired wireless transceivers, and;
transmit the received data or the logistics data to a logistics computing system.

10. A dolly identification system as per claim 9, wherein the logistics computing system is configured to:
receive the one or more logistics data,
process the received logistics data,
identify one or more dollies that have been paired and/or the order of the dollies that are connected.

11. A dolly identification system as per claim 1, wherein the towing vehicle pairing scanner is oriented to face a coupling direction of the mechanical coupler such that the line of sight of the towing vehicle pairing scanner is in the coupling direction of the mechanical coupler.

12. A dolly identification system as per claim 11, wherein each dolly comprises a link that is complementary to the mechanical coupler and configured to removably attach to the mechanical coupler to removably connect the dolly to the towing vehicle, and
wherein the wireless transceiver oriented to face in a coupling direction of the link.

13. A dolly identification system as per claim 12, wherein the wireless transceiver is positioned on or adjacent the mechanical link and is oriented to face in the direction of the link such that the wireless transceiver has line of sight to the pairing scanner when the dolly is coupled to the towing vehicle.

14. A dolly identification system as per claim 12, wherein each dolly comprises a dolly pairing scanner, wherein the dolly pairing scanner is positioned on the dolly and configured to detect signals broadcast by one or more wireless transceivers,
the dolly pairing scanner further configured to determine the position of a detected wireless transceiver and associated dolly based on the ID value and RSSI value in the pairing signal received from each wireless transceiver.

15. A dolly identification system as per claim 9, wherein each wireless transceiver is an RF transceiver configured to transmit RF signals, the towing vehicle pairing scanner is an RF pairing scanner configured to detect and receive RF signals, and wherein the wireless transceivers and the towing vehicle pairing scanner defining a wireless RF network.

16. A dolly identification system as per 15, wherein each wireless transceiver is a Bluetooth transceiver and the towing vehicle pairing scanner is a Bluetooth pairing scanner,
the wireless transceiver and towing vehicle pairing scanner are configured to communicate by Bluetooth protocol,
the wireless transceivers and the towing vehicle pairing scanner forming a piconet network.

17. A dolly identification system as per claim 14, wherein data signals are transmitted from a dolly pairing scanner on a first dolly of the plurality of dollies to the wireless transceiver on the same dolly,
the data signals are transmitted to the dolly pairing scanner of a second dolly adjacent to first the dolly via the wireless transceiver of the first dolly, such that data signals being routed from one dolly to the next until the towing vehicle pairing scanner receives the data signals, and;
the towing vehicle pairing scanner configured to transmit the received data signals to a logistics computing system.

18. An airport dolly identification and management system for tracking one or more dollies comprising:
a towing vehicle,
the towing vehicle comprises a towing vehicle pairing scanner disposed on the towing vehicle,
a plurality of dollies, each dolly comprising a wireless transceiver,
the dollies are configured to mechanically couple to each other in series and couple to the towing vehicle, wherein the towing vehicle is adapted to tow all the dollies,
wherein each wireless transceiver is configured to broadcast advertise signals,
wherein the towing vehicle pairing scanner is configured to receive the broadcast advertise signals from each wireless transceiver associated with a dolly, the towing vehicle paring scanner is configured to:
identify each wireless transceiver and associated dolly based on the RSSI value and ID encoded within the broadcast advertise signals,
wirelessly pair with one or more wireless transceivers once the wireless transceivers are within pairing range, wherein the range is determined based on the RSSI value,
wherein the paired wireless transceivers and the towing vehicle pairing scanner forming a wireless RF network that utilises signals in a frequency range of 2.4 GHz to 5 GHZ,
receive data including logistics data from the paired wireless transceivers,
transmit the received data or the logistics data to a remote computing system, and;
wherein the logistics data comprises one or more of:
location of the dolly,
pairing status,
occupancy status,
type of load being carried.

19. An airport dolly identification and management system as per claim 18, wherein each wireless transceiver comprises a Bluetooth transceiver or a Wi-Fi transceiver,
the towing vehicle pairing scanner comprising a Bluetooth scanner or a Wi-Fi scanner, and;
the towing vehicle pairing scanner configured to receive data signals from each wireless transceiver over the network either directly or routed through a dolly pairing scanner.

20. A dolly identification method comprising the steps of:
receiving at a towing vehicle pairing scanner one or more pairing signals broadcast by a wireless transceiver,
wherein the towing vehicle pairing is configured to be provided on a towing vehicle and the wireless transceiver is provided on a dolly, in use, the dolly is configured to mechanically couple to the towing vehicle,
wherein the dolly is configured to carry equipment,
wirelessly pairing the towing vehicle pairing scanner with the wireless transceiver based at least on the RSSI value of the pairing signal,
receiving at the towing vehicle pairing scanner data signals from the wireless transceiver including one or more logistics data,
wherein the logistics data comprising one or more of:
location of the dolly,
pairing status,
occupancy status,
type of load being carried,
transmitting the received logistics data to a logistics computing system.
